(19) United States
(12) Patent Application Publication
(10) Pub. No.: US 2005/0250908 A1
(43) Pub. Date: Nov. 10, 2005

(54) Polymer melt additive composition and use thereof

(75) Inventors: Joris Briers, Antwerpen (BE); Maria P. Dillon, St. Paul, MN (US); Jeffrey G. Linert, Woodbury, MN (US); Rik R. Nuyttens, Sint-Niklaas (BE)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/841,758

(22) Filed: May 7, 2004

(51) Int. Cl. C08L 27/12

(52) U.S. Cl. 525/199

(57) ABSTRACT

The present invention provides a polymer melt additive composition in the form of a powder for use as an additive in the melt processing of a host polymer, the polymer melt additive composition comprising particles of fibrillating polytetrafluoroethylene and an effective amount of a fluorothermoplast to prevent agglomeration of said particles of fibrillating polytetrafluoroethylene. It has been found that the polymer melt additive composition can improve the melt strength of a host polymer and is an easy to handle powder.

### FIELD OF THE PRESENT INVENTION

The present invention relates to a polymer melt additive composition comprising fibrillating polytetrafluoroethylene (PTFE). In particular the present invention relates to a polymer melt additive composition in which premature fibrillation or agglomeration of PTFE particles is prevented. Additionally, the present invention relates to the use of the polymer melt additive composition in melt processing of a host polymer. The invention further relates to mixtures of the polymer melt additive composition and a thermoplastic host polymer as well as to extruded articles produced therewith.

### BACKGROUND OF THE INVENTION

The use of fluoropolymer as melt additives for thermoplastic host polymers, typically non-fluorinated host polymers, is well known in the art. Typically, fluoropolymer melt additives are being used to improve the melt processing of a host polymer. For example, fluoropolymer melt additives are used to increase the extrusion speed of the host polymer without causing surface roughness to occur in the extrudate or melt fracture.

Fluoropolymers may be used to avoid or mitigate other problems occurring in the extrusion of thermoplastic polymers. Such problems include for example a build up of the polymer at the orifice of the die (known as die build up or die drool), increase in back pressure during extrusion runs, and excessive degradation or low melt strength of the polymer due to high extrusion temperatures. These problems slow the extrusion process either because the process must be stopped to clean the equipment or because the process must be run at a lower speed.

Certain fluorocarbon processing aids are known to partially alleviate melt defects in extrudable thermoplastic hydrocarbon polymers and allow for faster, more efficient extrusion. U.S. Pat. No. 3,125,547 to Blatz, for example, first described the use of fluorocarbon polymer process aids with melt-extrudable hydrocarbon polymers wherein the fluorinated polymers are homopolymers and copolymers of fluorinated olefins having an atomic fluorine to carbon ratio of at least 1:2 and wherein the fluorocarbon polymers have melt flow characteristics similar to that of the hydrocarbon polymers.

U.S. Pat. No. 4,904,735 (Chapman, Jr. et al.) describes a fluorinated processing aid for use with a difficultly melt-processable polymer comprising (1) a fluorocarbon copolymer which at the melt-processing temperature of the difficultly melt-processable polymer is either in a melted form if crystalline, or is above its glass transition temperature if amorphous, and (2) at least one tetrafluoroethylene homopolymer or copolymer of tetrafluoroethylene and at least one monomer copolymerizable therewith wherein the mole ratio is at least 1:1, and which is solid at the melt-processable temperature of the difficultly melt-processable polymer.

Other disclosures of the use of fluoropolymer melt additive compositions include U.S. Pat. No. 5,397,897, U.S. Pat. No. 5,064,594, U.S. Pat. No. 5,132,368, U.S. Pat. No. 5,464,904 U.S. Pat. Nos. 5,015,693, 4,855,013, U.S. Pat. No. 5,710,217 and U.S. Pat. No. 6,277,919 and WO 02/066544. Generally, these disclosures relate to more easily extrusion of the host polymer, i.e. reduce melt fracture and/or allow processing at higher rates.

Fluoropolymer melt additives have also been used to improve mechanical properties of the thermoplastic host polymer to which they are added. For example, EP 822226 discloses a mixture of PTFE particles having a size of less than 10 μm and organic polymer particles. It is taught that such additive improves mold workability and enhances the mechanical characteristics of the thermoplastic polymer.

The use of fibrillating PTFE as an additive to thermoplastic host polymer melts can improve the melt strength and can produce flame retarding polymer products. The flame-retarding properties are typically achieved because the extruded polymer product contains PTFE fibers, which results in anti-dripping properties of the resin.

However, the fibrillating properties of PTFE also present problems in handling of the PTFE melt additive, i.e. agglomeration of the PTFE is to be avoided. Accordingly, typically the fibrillating PTFE should be handled such as to avoid applying shear to thereto or otherwise at low temperatures to avoid fibrillation and/or agglomeration to occur before PTFE is added to the melt of the host polymer. This complicates the manufacturing process and it would be desirable to find better ways to avoid agglomeration of the PTFE without however inhibiting fibrillation of the PTFE during the extrusion with the host polymer when fibrillation should occur to achieve the desired properties of improved melt strength and flame-retarding properties of the extruded product.

### SUMMARY OF THE INVENTION

In one aspect, the present invention provides a polymer melt additive composition for use as an additive in the melt processing of a host polymer, the polymer melt additive composition comprising fibrillating polytetrafluoroethylene and an effective amount of a fluorothermoplast to prevent agglomeration of the fibrillating polytetrafluoroethylene (“PTFE”). By the term ‘prevent agglomeration’ is meant that the fibrillating PTFE should not agglomerate at all during manufacturing and handling of the melt additive composition prior to addition to the melt processing of a host polymer or the particles should not agglomerate to an extent that would substantially impair the ability of the additive composition to improve the melt strength or that would result in clumps of the composition being formed.

It has been found that the polymer melt additive composition can improve the melt strength of a host polymer. Additionally, the polymer melt additive composition can be easily handled without a special need for precautions against fibrillation of the fibrillating PTFE and/or agglomeration of the PTFE particles.

By the term ‘host polymer’ is typically meant a thermoplastic polymer for which it is desired to improve the melt strength and with which the melt additive composition is incompatible. Typically, the host polymer is a non-fluorinated polymer or a polymer having a degree of fluorination such that the ratio of fluorine atoms to carbon atoms is less than 1:1.

By the term ‘fluorothermoplast’ is meant a fluoropolymer, i.e. a polymer having a fluorinated backbone and a ratio of fluorine atoms to carbon atoms in the backbone of at least 1:1, preferably at least 1.5:1. The fluoropolymer is thermoplastic, i.e. can be melted upon heating and can be processed by melt processing equipment typically used for non-fluorinated thermoplastic polymers. The fluoropolymer has a clearly distinguishable melting point and is typically semi-crystalline.

By the term ‘fibrillating PTFE’ is meant a polytetrafluoroethylene that is capable of fibrillating during melt processing of a host polymer.

In a further aspect, the present invention relates to a mixture of host polymer and an effective amount of a polymer melt additive composition as defined above to improve the melt strength of said host polymer.

In a still further aspect, the invention relates to the extrusion of aforementioned mixture and to an extruded product obtained therewith.

### DETAILED DESCRIPTION OF THE INVENTION

The fibrillating PTFE is typically a homopolymer of tetrafluoroethylene (TFE) but may also be a copolymer of TFE with for example another fluorinated monomer such as chlorotrifluoroethylene (CTFE), a perfluorinated vinyl ether such as perfluoromethyl vinyl ether (PMVE) or a perfluorinated olefin such as hexafluoropropylene (HFP). The amount of the fluorinated comonomer should however be low enough so as to obtain a high molecular weight polymer that is not processible from the melt. This means in general that the melt viscosity of the polymer should be more than 10¹⁰ Pa.s. Typically the amount of the optional comonomers should not be more than 1% so that the PTFE conforms to the ISO 12086 standard defining non-melt processible PTFE. Such copolymers of TFE are known in the art as modified PTFE.

The fibrillating PTFE typically has an average particle size (number average) of not more than 10 μm. Generally the average particle size of the fibrillating PTFE will be between 50 nm and 5 μm, for example between 100 nm and 1 μm. A practical range may be from 50 to 500 nm. Conveniently, fibrillating PTFE is produced via aqueous emulsion polymerization.

The fluorothermoplast used in the melt additive composition is typically a semi-crystalline fluoropolymer. Typically the fluorothermoplast should have a melting point such that the fluorothermoplast is in its molten state under the melt processing conditions used for processing the host polymer. As many of the host polymers that are typically considered for use in this invention have a melt processing temperature in the range of 150 to 320° C., fluorothermoplasts having a melting point of 100 to 310° C. are generally desired for use in this invention. Preferably, the fluorothermoplast has a melting point of between 100 and 250° C. Frequently, the fluorothermoplast will have a melting point of not more than 200° C.

The fluorothermoplast should be used in amount effective to avoid agglomeration of the particles of fibrillating PTFE. The effective amount can be easily determined by one skilled in the art with routine experimentation. Typically, an effective amount of fluorothermoplast is an amount of at least 10% by weight based on the weight of fibrillating PTFE. It will generally be desired to maximize the amount of PTFE in the melt additive composition as a higher amount of PTFE in the melt additive composition will make the latter more effective in achieving desired effects when added to the host polymer melt such as for example increasing the melt strength of the host polymer. A practical range of the amount of fluorothermoplast in the melt additive composition is at least 10% by weight, for example between 10 and 60% by weight, conveniently between 12 and 50% by weight, commonly between 15 and 30% by weight based on the total weight of fibrillating PTFE.

Fluorothermoplasts, for use in the melt additive composition include fluoropolymers that comprise interpolymerized units derived from at least one fluorinated, ethylenically unsaturated monomer, preferably two or more monomers, of the formula
RCF═CR₂ (I)
wherein each R is independently selected from H, F, Cl, alkyl of from 1 to 8 carbon atoms, aryl of from 1 to 8 carbon atoms, cyclic alkyl of from 1 to 10 carbon atoms, or perfluoroalkyl of from 1 to 8 carbon atoms. The R group preferably contains from 1 to 3 carbon atoms. In this monomer each R group may be the same as each of the other R groups. Alternatively, each R group may be different from one or more of the other R groups.

The fluoropolymer may also comprise a copolymer derived from the interpolymerization of at least one formula I monomer with at least one nonfluorinated, copolymerizable comonomer having the formula:
R¹₂C═CR¹₂ (II)
wherein each of R¹ is independently selected from H, Cl, or an alkyl group of from 1 to 8 carbon atoms, a cyclic alkyl group of from 1 to 10 carbon atoms, or an aryl group of from 1 to 8 carbon atoms. R¹ preferably contains from 1 to 3 carbon atoms.

Representative examples of useful fluorinated formula I monomers include, but are not limited to vinylidene fluoride, tetrafluoroethylene, hexafluoropropylene, chlorotrifluoroethylene, 2-chloropentafluoropropene, dichlorodifluoroethylene, 1,1-dichlorofluoroethylene, and mixtures thereof. Perfluoro-1,3-dioxoles may also be used. The perfluoro-1,3-dioxole monomers and their copolymers are described in U.S. Pat. No. 4,558,141 (Squires).

Representative examples of useful formula II monomers include ethylene, propylene, etc.

Particular examples of fluoropolymers include polyvinylidene fluoride, fluoropolymers derived from the interpolymerization of two or more different formula I monomers and fluoropolymers derived from one or more formula I monomers with one or more formula II monomers. Examples of such polymers are those having interpolymerized units derived from vinylidene fluoride (VDF) and hexafluoropropylene (HFP); and those derived from tetrafluoroethylene (TFE) and at least 5 weight % of at least one copolymerizable comonomer other than TFE. This latter class of fluoropolymers includes polymers of interpolymerized units derived from TFE and HFP; polymers of interpolymerized units derived from TFE, HFP and VDF; polymers of interpolymerized units derived from TFE, HFP and a formula II monomer; and polymers derived from interpolymerized units derived from TFE and a formula II monomer.

The fluorothermoplast may be produced by any of the known polymerization techniques although aqueous emulsion polymerization will generally be preferred for obtaining the melt-processible thermoplastic fluoropolymer.

The melt additive composition is preferably prepared by blending an aqueous dispersion of the fibrillating PTFE with an aqueous dispersion of the fluorothermoplast and coagulating the mixed dispersion followed by drying the product. Such a method is disclosed in for example WO 01/27197. Such method offers the advantage that fibrillation of the PTFE is avoided while preparing the melt additive composition. It is however also possible to prepare the melt additive composition by dry blending the PTFE and the fluorothermoplast. However, in the latter case, care should be taken that the shear forces applied in the blending operation do not cause the PTFE to fibrillate. Accordingly, blending should then typically be carried out at low temperatures at which fibrillation can be avoided. Once the PTFE is blended with an effective amount of the fluorothermoplast, fibrillation of the PTFE may be prevented and the melt additive can thus be handled in a conventional way. The melt additive composition may contain further adjuvants to obtain particular desired properties.

The melt additive composition is used in the melt processing of a host polymer. Host polymers for use in connection with the melt additive composition include polymers with which the melt additive composition is incompatible. Typically, the host polymer is a non-fluorinated or marginally fluorinated thermoplastic polymer.

A wide variety of polymers are useful as the host polymer in the present invention and include both hydrocarbon and non-hydrocarbon polymers. Examples of useful host polymers include, but are not limited to, polyamides, chlorinated polyethylene, polyimides, polyurethanes, polyolefins, polystyrenes, polyesters, polycarbonates, polyketones, polyureas, polyvinyl resins such as polyvinyl choride, polyacrylates and polymethylacrylates.

A particularly useful class of host polymers are polyolefins. Representative examples of polyolefins useful in the present invention are polyethylene, polypropylene, poly(1-butene), poly(3-methylbutene), poly(4-methylpentene) and copolymers of ethylene with propylene, 1-butene, 1-hexene, 1-octene, 1-decene, 4-methyl-1-pentene, and 1-octadecene.

Representative blends of polyolefins useful in the invention are blends of polyethylene and polypropylene, linear or branched low-density polyethylenes, high-density polyethylenes, and polyethylene and olefin copolymers containing said copolymerizable monomers, some of which are described below, e.g., ethylene and acrylic acid copolymers; ethylene and methyl acrylate copolymers; ethylene and ethyl acrylate copolymers; ethylene and vinyl acetate copolymers; ethylene, acrylic acid, and ethyl acrylate copolymers; and ethylene, acrylic acid, and vinyl acetate copolymers.

The polyolefins may be obtained by the homopolymerization or copolymerization of olefins, as well as copolymers of one or more olefins and up to about 30 weight percent or more, but preferably 20 weight percent or less, of one or more monomers that are copolymerizable with such olefins, e.g. vinyl ester compounds such as vinyl acetate. The olefins may be characterized by the general structure CH₂═CHR, wherein R is a hydrogen or an alkyl radical, and generally, the alkyl radical contains not more than 10 carbon atoms, preferably from one to six carbon atoms. Representative olefins are ethylene, propylene, 1-butene, 1-hexene, 4-methyl-1-pentene, and 1-octene. Representative monomers that are copolymerizable with the olefins include: vinyl ester monomers such as vinyl acetate, vinyl propionate, vinyl butyrate, vinyl chloroacetate, and vinyl chloropropionate; acrylic and alpha-alkyl acrylic acid monomers and their alkyl esters, amides, and nitriles such as acrylic acid, methacrylic acid, ethacrylic acid, methyl acrylate, ethyl acrylate, N,N-dimethyl acrylamide, methacrylamide, and acrylonitrile; vinyl aryl monomers such as styrene, o-methoxystyrene, p-methoxystyrene, and vinyl naphthalene; vinyl and vinylidene halidemonomers such as vinyl chloride, vinylidene chloride, and vinylidene bromide; alkyl ester monomers of maleic and fumaric acid and anhydrides thereof such as dimethyl maleate, diethyl maleate, and maleic anhydride; vinyl alkyl ether monomers such as vinyl methyl ether, vinyl ethyl ether, vinyl isobutyl ether, and 2-chloroethyl vinyl ether; vinyl pyridine monomers; N-vinyl carbazole monomers; and N-vinyl pyrolidine monomers.

Useful host polymers also include the metallic salts of the olefin copolymers, or blends thereof, that contain free carboxylic acid groups. Illustrative of the metals that can be used to provide the salts of said carboxylic acids polymers are the one, two, and three valence metals such as sodium, lithium, potassium, calcium, magnesium, aluminum, barium, zinc, zirconium, beryllium, iron, nickel, and cobalt.

Useful host polymers also include blends of various thermoplastic polymers and blends thereof containing conventional adjuvants such as antioxidants, light stabilizers, fillers, antiblocking agents, and pigments.

The host polymers may be used in the form of powders, pellets, granules, or in any other extrudable form. The most preferred olefin polymers useful in the invention are hydrocarbon polymers such as homopolymers of ethylene and propylene or copolymers of ethylene and 1-butene, 1-hexene, 1-octene, 4-methyl-1-pentene, propylene, vinyl acetate and methyl acrylate.

A mixture of the melt additive composition and the host polymer can be prepared by any of a variety of ways. For example, the host polymer and the melt additive composition can be combined together by any of the blending means usually employed in the plastics industry, such as with a compounding mill, a Banbury mixer, or a mixing extruder in which the fluoropolymer is uniformly distributed throughout the host polymer. The melt additive composition and the host polymer may be used in the form, for example, of a powder, a pellet, or a granular product. The components are typically dry-blended in the solid state as particulates. A mixture of the melt additive composition and the host polymer may be used as a so-called masterbatch. Such masterbatch typically will contain the melt additive composition in a much higher amount as needed and will be diluted with pure host polymer upon melt processing of the host polymer. The amount of melt additive composition in a so-called masterbatch may vary between 2 and 20% by weight relative to the weight of host polymer, typically the amount is between 5 and 10%. Alternatively, the melt additive composition may be added directly to the melt of the host polymer while melt processing the latter.

The melt additive composition should be used in an effective amount to obtain the desired effect in the melt processing of the host polymer. Typically, the amount should be sufficient to cause an appreciable improvement in the melt strength of the host polymer. Generally, an effective amount here means that the melt additive composition is used in amount such that the mixture of host polymer and melt additive composition contains at least 500 ppm of fibrillating PTFE based on the amount of host polymer. For example, an effective amount of melt additive composition in the mixture with the host polymer may be such that the amount of fibrillating PTFE is between 500 and 50 000 ppm, conveniently between 800 and 20 000 ppm or between 1000 and 15 000 ppm based on the amount of host polymer.

The mixture of host polymer and melt additive composition is typically melt-processed at a temperature from 180° C. to 280° C., although optimum operating temperatures are selected depending upon the melting point, melt viscosity, and thermal stability of the blend. Different types of extruders that may be used to extrude the compositions of this invention are described, for example, by Rauwendaal, C., “Polymer Extrusion,” Hansen Publishers, p. 23-48, 1986. The die design of an extruder can vary, depending on the desired extrudate to be fabricated. For example, an annular die can be used to extrude tubing, useful in making fuel line hose, such as that described in U.S. Pat. No. 5,284,184 (Noone et al.), which description is incorporated herein by reference.

The melt additive composition is useful in the extrusion of host polymers, which includes for example, extrusion of films, extrusion blow molding, injection molding, pipe, wire and cable extrusion, vacuum molding, foam molding and calender molding. The melt additive composition is particularly useful in producing flame retarded resins and extruded articles based thereon.

The following examples are offered to aid in a better understanding of the present invention. These examples are not to be construed as an exhaustive compilation of all embodiments of the present invention and are not to be unnecessarily construed as limiting the scope of this invention.

### EXAMPLES

All percentages are by weight unless otherwise specified.

Preparation of Polymer Melt Additive Composition

Polymer melt additive composition PM-1 was made by blending 100 ml of a 60% PTFE dispersion (Dyneon™ TFX 5060) with 100 ml of a 30% dispersion of a semi-crystalline thermoplastic fluoropolymer having repeating units derived from tetrafluoroethylene (TFE), hexafluoropropylene (HFP) and vinylidene fluoride (VDF) (Dyneon™ THV 220D). Polymer melt additive composition CM-1 was prepared by blending 100 ml of a 60% PTFE dispersion (Dyneon™ TFX 5060) with 100 ml of a 30% dispersion of an amorphous fluoropolymer of HFP (38%) and VDF (62%) and having a Mooney viscosity of 36. Comparative polymer melt additive C-PM was made from a 60% dispersion of PTFE (Dyneon™ TFX 5060).

The dispersions were kept overnight at −20° C. After warming up to room temperature, the mixtures were coagulated. The coagulated mixtures were filtered and dried at 120° C. overnight.

### Example 1 and Comparative Examples C-1 to C-3

In example 1 and comparative example C-1, 20 g of dried polymer melt additive PM-1 and CM-1 respectively were blended with 180 g polypropylene (PP, Escorene™ 5012 F2; MFI: 2.9; available from ExxonMobil). The blends were melt mixed using a Haake Rheomix™ mixing bowl fitted with roller blades, at a temperature of 210° C. during 8 minutes. The torque was monitored with the Rheocord™ System 90 torque rheometer during the mixing. Comparative measurements were done with a blend of 20 g PTFE (CM-2) and 180 g PP Escorene™ 5012 (comparative example C-2) and with PP Escorene™ 5012 without polymer melt additive (comparative example C-3). The equilibrated torque values recorded after 8 min are given in table 1.

TABLE 1
torque values of polypropylene (PP) - polymer melt additive blends

| Ex No | Composition | Torque (Nm) |
|---|---|---|
| 1 | PP + PM-1 | 63 |
| C-1 | PP + CM-1 | 61 |
| C-2 | PP + CM-2 | 50 |
| C-3 | PP | 28 |

As can be seen from the above table, the polymer melt additive composition according to the invention using a fluorothermoplast improved the melt strength. Additionally, the melt additive composition appeared as a free flowing powder and was easy to handle without indications of premature fibrillation of the PTFE. Polymer melt additive composition CM-1, which used an amorphous melt-processible thermoplastic fluoropolymer also improved the melt strength but did not appear as a free flowing powder and was equally difficult to handle as melt additive composition CM-2 which only contained the fibrillating PTFE.

### Example 2 and Comparative Examples C-4 and C-5

In example 2, polypropylene with polymer melt additive compositions were dry-blended and compounded using a Berstorff twin screw extruder with temp zones 220-230° C. and a melt temperature of 230° C.

In example 2 a 50:50 blend of Aristech PP 12MI and BP Amoco 12MI PP containing 1% PM-1 were injection molded. Comparative examples were made of the PP blend mentioned above without polymer melt additive (C-4) and of the PP blend with 1% PTFE (C-5).

Injection molding was completed using a Cincinati Milacron-Fanuc Roboshot 110R number Robo11OR-55. Injection molding zone temperatures were set at 230, 220, 220, 210° C. (melt temperature: 216° C.). Injection rate was two stage; high injection speed 90 mm/sec until 12 mm than 60 mm/sec until the injection-pack transition at 9 mm. Other parameters of the injection molder were as follows: backpressure 100 kg/cm2; RPM: 100; shot size 63 mm; cool time 15 seconds; pack 450 for 3 sec. The mold used was a multi-cavity TSM mold with 160 mm and 62 mm long dumbbell, 125 mm by 12.5 wide by 3 mm flex bar, and three discs (62 mm, 25.5 mm and 8 mm diameters). All cavities were open and all the parts were single gated. The mold temp was set at 27° C.

The storage modulus G′ was measured using an Ares Rheometer (now TA Instruments). Injection molded 2.55 cm by 1.1 mm discs were analyzed at 240° C. under nitrogen between 2.5 cm diameter parallel plates. The sample discs were placed between preheated plates (at 240° C.), and the gap set to 1.1 m. Then the sample was trimmed to the diameter of the plates. The gap was reduced to 1 mm to form a meniscus. The test began after 100 sec equilibration. The strain rate was set at 10%. Shear rate varied from 0.1 rad/sec to 200 rad/sec. The rheology data (specifically storage modulus (G′)) collected for each formulation was compared at 1 rad/sec.

The results are given in table 2.

TABLE 2
storage modulus G′

| Ex No. | Composition | G′ (Mpa) |
|---|---|---|
| 2 | PP + 1% PM-1 | 4760 |
| C-4 | PP | 2389 |
| C-5 | PP + 1% CM-2 | 4144 |

The results indicated that the storage modulus G′ was increased by using a polymer melt additive composition comprising a blend of PTFE with a fluorothermoplast. Better mechanical properties were obtained although the level of fluorochemical in the polymer melt additive was decreased.

1. A polymer melt additive composition for use as an additive in the melt processing of a host polymer, the polymer melt additive composition comprising fibrillating polytetrafluoroethylene and an effective amount of a fluorothermoplast to prevent agglomeration of said fibrillating polytetrafluoroethylene.

2. A polymer melt additive composition according to claim 1 wherein said fibrillating polytetrafluoroethylene is in the form of particles having an average particle size of not more than 10 μm.

3. A polymer melt additive composition according to claim 1 wherein said polytetrafluoroethylene is a non-melt processable polytetrafluoroethylene.

4. A polymer melt additive composition according to claim 1 wherein the polymer melt additive composition comprises said fluorothermoplast in an amount of at least 10% by weight relative to the total weight of said particles of fibrillating polytetrafluoroethylene.

5. A polymer melt additive composition according to claim 4 wherein said fluorothermoplast has a melting temperature between 100 and 310° C.

6. A polymer melt additive composition according to claim 4 wherein the amount of said fluorothermoplast is between 10 and 50% by weight of said total weight of said fibrillating polytetrafluoroethylene.

7. A polymer melt additive composition according to claim 4 wherein said fluorothermoplast has a melting temperature of not more than 250° C.

8. A polymer melt additive composition according to claim 1 further comprising a host polymer.

9. A method for melt processing a host polymer, comprising extruding an admixture of a host polymer and polymer melt additive composition of claim 1 in an amount effective to improve the melt strength to the host polymer.

10. A mixture of thermoplastic host polymer and a polymer melt additive composition as defined in claim 1 in an effective amount to improve the melt strength of said host polymer.

11. A mixture according to claim 10 wherein said host polymer is a non-fluorinated polymer.

12. A mixture according to claim 10 wherein said non-fluorinated polymer is a polyolefin.

13. A mixture according to claim 10 wherein said fibrillating polytetrafluoroethylene is in the form of particles having an average particle size of not more than 10 μm.

14. A mixture according to claim 10 wherein the amount of said fibrillating polytetrafluoroethylene is between 500 and 50 000 ppm based on the amount of said host polymer.
